(19) United States
(12) Patent Application Publication
(10) Pub. No.: US 2023/0135050 A1
(43) Pub. Date: May 4, 2023

(54) SYSTEMS AND METHODS FOR DIGITAL IMPRESSION AND MEMORIALIZATION

(71) Applicant: LEGAC-E, LLC, Horseheads, NY (US)

(72) Inventor: Karim W. SADIK, Horseheads, NY (US)

(73) Assignee: LEGAC-E, LLC, Horseheads, NY (US)

(21) Appl. No.: 18/092,067

(22) Filed: Dec. 30, 2022

Related U.S. Application Data
(63) Continuation of application No. PCT/US2021/032887, filed on May 18, 2021.
(60) Provisional application No. 63/108,112, filed on Oct. 30, 2020.

(51) Int. Cl. G06N 5/022; G06Q 50/00

(52) U.S. Cl. CPC G06N 5/022; G06Q 50/01

(57) ABSTRACT

A method for propagating a first user virtually via a digital legacy social media profile includes obtaining training data over an initial time period that includes user input data and/or accessed data relating. The method includes obtaining configuration settings from the first user, the configuration settings including at least one of a filter setting or one or more nominees. The method includes generating a digital legacy social media profile of the first user using the training data and the one or more configuration settings and launching the digital legacy social media profile on a server in response to an initiation. The method includes providing an option to present the digital legacy social media profile to at least a second user such that the digital legacy social media profile is accessible to the second user even when the digital legacy social media profile is inaccessible to the first user.

### CROSS-REFERENCE TO RELATED PATENT APPLICATIONS

This application is a continuation of International Application No. PCT/US2021/032887 filed May 18, 2021, which claims the benefit of and priority to U.S. Provisional Application No. 63/108,112, filed Oct. 30, 2020, the entire disclosure of each of which is incorporated by reference herein.

### FIELD

The present disclosure generally relates to digital impression and memorialization. More particularly, the present disclosure relates to digital impression and memorialization with mobile systems.

### BACKGROUND

Memorialization of a subject may be desired for numerous purposes. Historically, memorialization efforts were incomplete and relied on the oral tradition or written records.

### SUMMARY

One implementation of the present disclosure is a method for propagating a first user virtually via a digital legacy social media profile, according to some embodiments. In some embodiments, the method includes obtaining training data over an initial time period, the training data including at least one of user input data or accessed data relating to the first user. In some embodiments, the method includes obtaining one or more configuration settings from the first user, the configuration settings including at least one of a filter setting or one or more nominees. In some embodiments, the method includes generating a digital legacy social media profile of the first user using the training data and the one or more configuration settings. In some embodiments, the method includes launching the digital legacy social media profile on a server in response to an initiation. In some embodiments, the method includes providing an option to present the digital legacy social media profile to at least a second user such that the digital legacy social media profile is accessible to the second user even when the digital legacy social media profile is inaccessible to the first user.

In some embodiments, the accessed data includes one or more social media profiles or social media profile data of the first user.

In some embodiments, the user input data is provided by the first user in response to a prompt to input data. In some embodiments, the prompt is at least one inquiry provided to the first user and the user input data is a response to the at least one inquiry.

In some embodiments, the accessed data includes a third party social media profile of the first user. In some embodiments, the first user provides access to the third party social media profile and data of the third party social media profile.

In some embodiments, the filter setting includes a user preference regarding (a) one or more categories of content and/or (b) specific content to be designated as hidden from the digital legacy social media profile.

In some embodiments, the digital legacy social media profile is configured to automatically interact with the second user and/or generate new content to populate a feed of the digital legacy social media profile, the new content generated based on the training data.

In some embodiments, the one or more nominees are one or more users empowered to access or adjust privacy settings or configuration settings of the digital legacy social media profile.

In some embodiments, the digital legacy social media profile comprises at least one of a public profile comprising public content or a private profile comprising private content.

In some embodiments, the digital legacy social media profile is configured to send direct messages to the second user in response to a scheduled event or date or receiving a direct message from the second user.

Another implementation of the present disclosure is a method for creating a digital legacy profile for a first user, according to some embodiments. In some embodiments, the method includes requesting access to input data of the first user, the input data including data or media that is stored locally on a device of the first user and data or media of the first user stored remotely. In some embodiments, the method includes obtaining one or more configuration settings from the first user, the one or more configuration settings including a filter setting for content expungement, and a theme setting for content presentation. In some embodiments, the method includes prompting the first user to input responses to inquiries presented locally on the device of the first user and storing the responses. In some embodiments, the method includes determining whether an initiation condition is satisfied, and in response to the initiation condition being satisfied, generating a digital legacy profile for the first user based on the input data, the one or more configuration settings, and the responses, and providing the digital legacy profile to a second user.

In some embodiments, the filter setting identifies one or more categories of content or specific content designated for removal when the digital legacy profile is provided to the second user.

In some embodiments, the digital legacy profile is provided to the second user according to the theme setting for content presentation, the theme setting for content presentation comprising at least one of a cultural, a religious, a political, or a personality setting.

In some embodiments, the method further includes receiving a new content setting, the new content setting indicating a category of content to be posted on the digital legacy profile and a condition for posting the content on the digital legacy profile.

In some embodiments, the method further includes receiving a setting for an automated reply message, the setting including a condition to trigger the automated reply message, and the automated reply message.

In some embodiments, the one or more configuration settings are obtained from the first user via a slider interface, the slider interface including multiple character toggles for the digital legacy profile, and multiple sliders for receiving a value of an associated one of the plurality of character toggles.

Another implementation of the present disclosure is a method for providing a digital legacy profile for a first user to a second user, according to some embodiments. The method includes generating the digital legacy profile based on training data and one or more configuration settings, according to some embodiments. The method also includes providing a second user with access to the digital legacy profile according to an access level of the second user, according to some embodiments. The method also includes automatically posting new content on the digital legacy profile based on the training data and the one or more configuration settings, the new content being automatically posted and the digital legacy profile automatically interacting with the second user when the digital legacy profile is inaccessible by the first user, according to some embodiments. The method also includes automatically interacting with the second user through the digital legacy profile, according to some embodiments.

In some embodiments, the method includes determining whether an initiation condition is met, the initiation condition indicating that the first user is unable to access or control the digital legacy profile. In some embodiments, the method includes providing the second user with access to the digital legacy profile and automatically posting new content on the digital legacy profile. The method further includes automatically interacting with the second user through the digital legacy profile, in response to the initiation condition being met.

In some embodiments, automatically interacting with the second user includes sending a direct message to the second user, responding to a direct message from the second user, posting new content directed towards the second user, or posting new content identifying the second user.

In some embodiments, the digital legacy profile includes at least one of a fulfillment section including one or more wishes of the first user, one or more images, quotes, or messages pre-selected by the first user, an interactive content section indicating additional information of the first user, a history section comprising media of the first user describing life events, a private message wall configured to receive at least one private message for the first user from the second user, an advice section comprising advice from the first user or instructional media from the first user, a favorites section including one or more lists of favorite objects, places, activities, memories, or media, a donation section configured to receive a donation from the second user and provide the donation to an organization as preferred by the first user, a bequeathing section for identification of one or more digital inheritance items comprising at least one of music, photos, digital game items, cryptocurrency, or virtual real estate, or a communal advice section configured to present crowdsourced advice to the second user.

In some embodiments, the digital legacy profile includes content assigned a private tag and content assigned a public tag, wherein the second user is provided with access to the content assigned the private tag based on the access level of the second user, the access level of the second user assigned by a third user designated as a manager of the digital legacy profile.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Reference will now be made in detail to various embodiments which are illustrated in the accompanying drawings. Whenever possible, the same reference numerals will be used throughout the drawings to refer to identical, functionally similar and/or structurally similar parts. The disclosure will become more fully understood from the following detailed description, taken in conjunction with the accompanying figures, wherein like reference numerals refer to like elements, in which:

FIG. 1 is a block diagram of a system for digital impression and memorialization, according to some embodiments.

FIG. 2 is a block diagram of the system of FIG. 1, showing a cloud computing system thereof in further detail, according to some embodiments.

FIG. 3 is a flow diagram of a process for digitally propagating a user, according to some embodiments.

FIG. 4 is a diagram of different phases of the system of FIG. 1, according to some embodiments.

FIG. 5 is a block diagram of an infrastructure implementation of the system of FIG. 1, according to some embodiments.

FIG. 6 is a flow diagram of different steps or user interfaces that can be provided to a user as the user navigates through a mobile application, according to some embodiments.

FIG. 7 is a diagram of a slider interface that can be provided to the user to obtain setting data, according to some embodiments.

FIG. 8 is a login user interface of a mobile application, according to some embodiments.

FIG. 9 is a registration user interface of the mobile application, according to some embodiments.

FIG. 10 is a feed interface of the mobile application, according to some embodiments.

FIG. 11 is a messaging interface of the mobile application, according to some embodiments.

FIG. 12 is a notification interface of the mobile application, according to some embodiments.

FIG. 13 is another feed interface of the mobile application, according to some embodiments.

FIG. 14 is a charity section interface of the mobile application, according to some embodiments.

FIG. 15 is a communal advice section interface of the mobile application, according to some embodiments.

FIG. 16 a profile interface for a user of the mobile application, according to some embodiments.

FIG. 17 is an interface of the mobile application for selecting next of kin, according to some embodiments.

FIG. 18 is a legacy profile for a user of the mobile application, according to some embodiments.

### DETAILED DESCRIPTION

### Overview

Referring generally to the FIGURES, systems and methods for propagating a user virtually are shown. Such systems and methods facilitate providing a digital impression of a user and memorializing of the user. In particular, the disclosed techniques allow for dynamic interaction with the user and meaningful engagement with a content-rich user profile.

The systems and methods can be implemented as a mobile application or applications in accordance with some embodiments.

In some embodiments, a user may launch the mobile application and provide different input data, different settings, and access to other social media profiles. The mobile application generates a digital legacy social media profile for the user based on the input data, the settings, and data from the other social media profiles. The mobile application can also prompt the user to periodically enter additional information. The profile can then be implemented on a social media platform when the user passes or permanently loses access to the profile. Different users on the social media platform can interact with and/or view content on the profile.

### System Overview

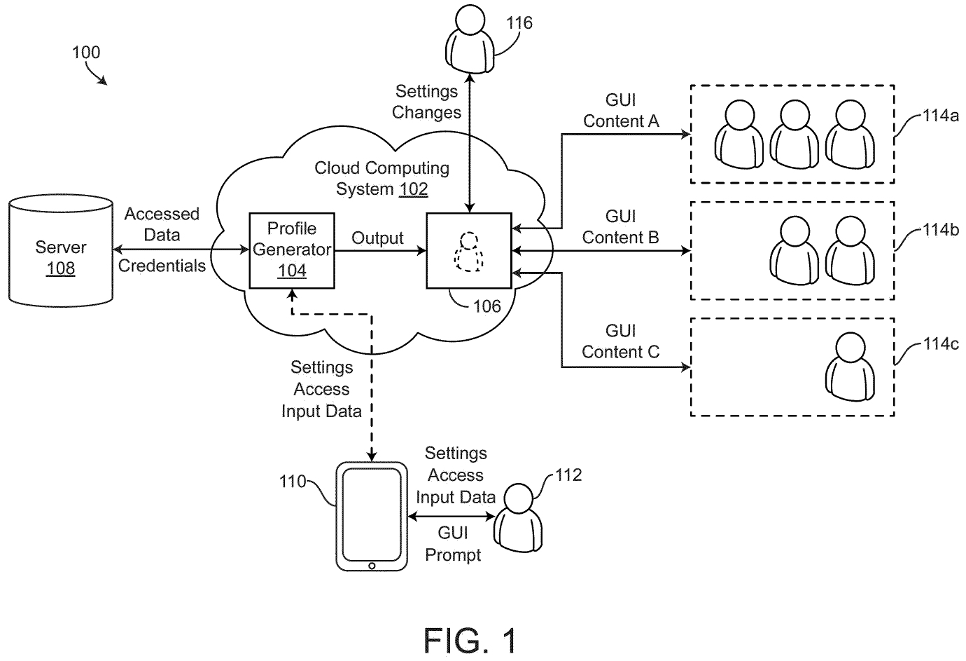

Referring particularly to FIG. 1, a system for digital impression and memorialization of a user, implemented as digital legacy system 100 is shown, according to an exemplary embodiment. Digital legacy system 100 can be implemented according to the infrastructure shown, or may be implemented in other infrastructures as described herein. Digital legacy system 100 is configured to collect various input data (e.g., from a user, from a user’s social media profile, from a user’s mobile device, etc.) to generate a digital legacy profile, a social media profile, a virtual profile, etc., shown as profile 106. Profile 106 may be an autonomous (e.g., an automatic) or a semi-autonomous profile that interacts with one or more groups of users 114. Profile 106 can be hosted on a social media platform (e.g., on a server) which can be accessed by the one or more groups of users 114 that have accounts on the social media platform. The one or more groups of users 114 can access and/or interact with profile 106 even when profile 106 is inaccessible to a user 112 upon which the profile 106 is based. In this way, profile 106 can function as a digital impression and/or a memorialization of user 112, even when user 112 is no longer present to interact with other users (e.g., because the user 112 is deceased or incapacitated, among other circumstances).

Referring still to FIG. 1, digital legacy system 100 includes a cloud computing system 102, a user device 110, and user 112. Cloud computing system 102 can include profile generator 104 and profile 106. Profile 106 can be generated by profile generator 104 of cloud computing system 102 and can be implemented on cloud computing system 102, a server of cloud computing system 102, or a different server thereof. Cloud computing system 102 can include processing circuitry, memory, one or more processors, etc., as described in greater detail below. Cloud computing system 102 generally includes processing circuitry for performing the tasks, methods, and functionality described herein, according to some embodiments. Cloud computing system 102 can be implemented on a remote processor, processing circuitry (e.g., at a single location) or can be distributed among different remote processing circuitry.

Cloud computing system 102 is configured to obtain training data from user 112 (e.g., via user device 110) and use the training data (e.g., at profile generator 104) to generate profile 106. The training data can include information or data regarding user 112 that is collected directly from user 112 (e.g., in response to a prompt, as a part of a data collection process, as a part of a survey or questionnaire, the “input data” described below, etc.). The training data can be obtained over an initial time period. The training data can also include information or data that is obtained from storage (e.g., memory) of user device 110 and/or from one or more social media profiles or remote storage associated with user 112 (e.g., shown as server 108).

User 112 can provide profile generator 104 with input data, desired settings (e.g., configuration settings) for profile 106, and access to various other data sources (e.g., social media profiles, data storage systems or services, etc.). The input data can include any of the input data described herein regarding user 112 and may be received in response to a prompt that is provided to user 112 via user device 110 (e.g., a prompt or notification including a question for the user 112 to collect data from the user 112). The input data can also at least partially be received in response to a questionnaire that is provided to the user 112 via user device 110 (e.g., when profile 106 is initially being set-up, when a mobile application is first loaded and used on mobile device 110, etc.). The input data can also at least partially be or include data that is stored locally at user device 110 (e.g., text message conversations, messaging conversations, audio files, video files, picture files, etc.).

The input data can also include access for cloud computing system 102 or profile generator 104 to other data sources. The access can be provided to cloud computing system 102 and/or profile generator 104 as login credentials for different accounts or profiles (e.g., social media profiles, data storage service login credentials, etc.). Cloud computing system 102 or profile generator 104 can then use the login credentials to access server 108 and obtain the accessed data from server 108. The accessed data can include multimedia (e.g., pictures, videos, photos, etc.), historic data (e.g., cache data stored by various apps remotely at server 108 or locally at user device 110, previously posted content, etc.), or any other data that is stored remotely and can be accessed through login credentials. The accessed data can include one or more social media profiles or social media profile data of the user 112, and may further include associated metadata. In some embodiments, the accessed data is a third party social media profile of user 1112. The user 112 may provide access to the third party social media profile and the data of the third party social media profile.

The input data can also include one or more settings for the generation, filtration, expungement, collection, and presentation of profile 106. The one or more settings may include designation of an administrator 116 (e.g., a nominee) for content, settings, or privacy management or adjustment of profile 106 when profile 106 is inaccessible by user 112. The settings can be used by profile generator 104 during generation of the profile 106, and can be used by profile 106 after profile 106 is generated and launched on a social media platform (e.g., on a server where profile 106 can be accessed by one or more groups of users 114). In this way, the settings can be used during a two-phase implementation of digital legacy system 100. For example, the settings can be used to generate the profile 106, and can be used for the autonomous or semi-autonomous activity of profile 106. The settings can be configuration settings, including filter settings. The filter settings can include a user preference regarding one or more categories of content and/or specific content to be designated or tagged as “hidden” on profile 106. For example, the filter settings may indicate that particular categories of content such as sexual or political content should be hidden or expunged from profile 106 before launching profile 106.

User device 110 is shown implemented as a mobile device 110, according to some embodiments. User device 110 can be implemented as a mobile device (e.g., a smartphone, a tablet, etc.) or any other device including processing circuitry, memory, one or more processors, communicability, etc., to perform the functionality of data collection and communication with cloud computing system 102 as described herein. User device 110 can include a display screen (e.g., an LCD screen, a touch screen, etc.) that is configured to display a graphic user interface (GUI) to provide instructions for data entry, prompt a user to provide input data, prompt a user to provide access or login credentials if desired, etc.

It should be understood that while profile generator 104 is described herein as collecting and/or obtaining input information from user 112, user device 110, or various profiles associated with user 112, profile generator 104 or cloud computing system 102 may require authorization or permission from user 112 before obtaining such data. In this way, the user 112 may voluntarily opt-in to provide the input data to cloud computing system 102 or profile generator 104.

Referring still to FIG. 1, digital legacy system 100 includes one or more groups of users 114 that access, view, or interact with profile 106, and administrator 116, who can be selected or designated by user 112 and can manage profile 106. Administrator 116 may manage a privacy setting of profile 106 to allow different users to view or interact with different features or content of profile 106. As shown in FIG. 1, profile 106 provides a GUI and content A to a first group of users 114a, while providing another GUI and content B to a second group of users 114b, and yet another GUI and content C to a third group of users 114c. The different groups of users 114a-114c may be provided content according to their respective privileges. For example, the first group of users 114a may be a first category (e.g., acquaintances) and can have access to a first level of content or features (e.g., content A). The second group of users 114b may be a second category (e.g., friends) and can have access to a second level of content or features (e.g., content B). Similarly, the third group of users 114c may be a third category (e.g., family) and can have access to a third level of content or features (e.g., content C). In some embodiments, the content that is provided to each of the different groups 114a-114c is determined by user 112 based on the settings. The administrator 116 can confirm or appoint new users to the different groups 114a-114c, or can upgrade users between the different groups.

The profile 106 can provide content (e.g., feed content, media content, etc.) as described herein to users 114. Different content or different categories of content can be assigned a tag (e.g., a private tag, a public tag, or a privacy level tag). The tag indicates which groups of users 114a-114c can view particular content. For example, the tag may indicate if the content is public or private content. If the content has a public tag, the content may be provided to any users 114 that have an access level indicating the users 114 can view public content (e.g., any users 114 of a social media platform). If the content has a private tag, the content may be provided to any users 114 that are approved as friends or family of user 112, thereby having elevated access levels. In some embodiments, the access level of the users 114 is determined, assigned, or approved by administrator 116. It should be understood that while the example described herein uses only two different tags for different privacy settings, any number of tags may be used (e.g., more than two, etc.).

### Cloud Computing System

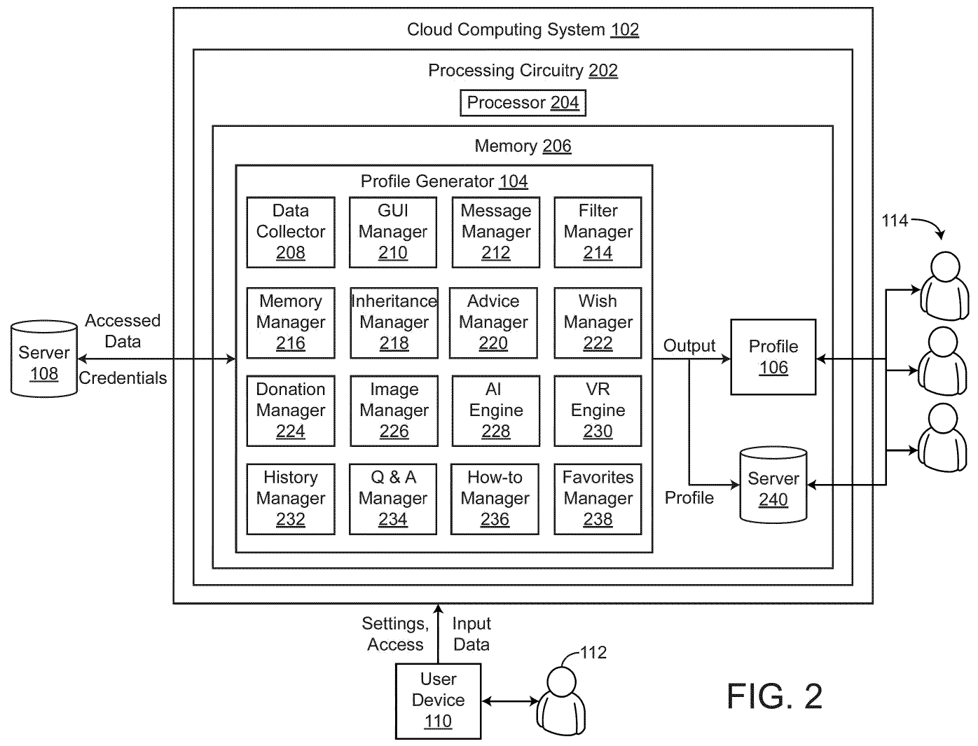

Referring now to FIG. 2, cloud computing system 102 is shown in greater detail, according to some embodiments. Cloud computing system 102 includes processing circuitry 202 including a processor 204 and memory 206. Processor 204 may be a general purpose or specific purpose processor, an application specific integrated circuit (ASIC), one or more field programmable gate arrays (FPGAs), a group of processing components, or other suitable processing components. Processor 204 is configured to execute computer code or instructions stored in memory 206 or received from other computer readable media (e.g., CDROM, network storage, a remote server, etc.).

Memory 206 may include one or more devices (e.g., memory units, memory devices, storage devices, etc.) for storing data and/or computer code for completing and/or facilitating the various processes described in the present disclosure. Memory 206 may include random access memory (RAM), read-only memory (ROM), hard drive storage, temporary storage, non-volatile memory, flash memory, optical memory, or any other suitable memory for storing software objects and/or computer instructions. Memory 206 may include database components, object code components, script components, or any other type of information structure for supporting the various activities and information structures described in the present disclosure. Memory 206 may be communicably connected to processor 204 via processing circuitry 202 and may include computer code for executing (e.g., by processor 204) one or more processes described herein. When processor 204 executes instructions stored in memory 206, processor 204 generally configures cloud computing system 102 (and more particularly processing circuitry 202) to complete such activities.

Referring still to FIG. 2, memory 206 includes the profile generator 104 that is configured to receive input data from the user device 110 and the server 108 to generate profile 106. Profile generator 104 includes a data collector, a GUI manager 210, a message manager 212, a filter manager 214, a memory manager 216, an inheritance manager 218, an advice manager 220, a wish manager 222, a donation manager 224, an image manager 226, an artificial intelligence (AI) engine 228, a virtual reality (VR) engine 230, a history manager, a question and answer (Q & A) manager 234, a how-to manager 236, and a favorites manager 238. Each of the portions of profile generator 104 are configured to perform the functionality as described herein to generate profile 106, or to generate content for profile 106.

### Data Collection

As shown in FIG. 2, profile generator 104 includes data collector 208, according to some embodiments. Data collector 208 is configured to facilitate the collection, retrieval, or request for various input data as required by one or more of GUI manager 210, message manager 212, filter manager 214, memory manager 216, inheritance manager 218, advice manager 220, wish manager 222, donation manager 224, image manager 226, AI engine 228, VR engine 230, history manager 232, Q & A manager 234, how-to manager 236, or favorites manager 238. Data collector 208 can obtain or retrieve input data from user device 110 and/or from server 108.

Data collector 208 can obtain data from user device 110 as a part of an initiation process. For example, when user device 110 first communicates with cloud computing system 102, data collector 208 or local software run at user device 110 may prompt the user 112 to answer a questionnaire regarding a variety of topics (e.g., memories, food preferences, likes/dislikes, etc.).

Data collector 208 can also provide notifications to the user 112 via user device 110 to periodically prompt the user 112 to input additional information. For example, data collector 208 can provide a notification to the user 112 through user device 110 with a question (e.g., “What is your favorite color?” “Where was your first date with your spouse?” etc.). The user 112 can then provide answers to the question which are provided to data collector 208 and are used to generate profile 106.

In some embodiments, data collector 208 is configured to provide notifications to the user 112 via user device 110 in a gamified manner. For example, data collector 208 may track a number of times that the user 112 responds to the notification or provides answers to the question of the notification. In some embodiments, data collector 208 is configured to use the number of times that the user 112 responds to the question of the notification as a score or rank. Based on the score or rank, the user 112 may obtain different rewards, unlock a feature, etc. For example, when the score or rank reaches a first level (e.g., a value of 10, indicating 10 answered questions), the user 112 may obtain a first reward or unlock a first feature, when the score or rank reaches a second level (e.g., a value of 20, indicating 20 answered questions), the user 112 may obtain a second reward or unlock a second feature, etc. In this way, different scores or ranks can allow the user 112 to obtain different rewards, ratings, or features. Advantageously, gamifying the notifications that are provided to the user 112 by the data collector 208 can facilitate uploading and entering of user information that can be used to generate profile 106.

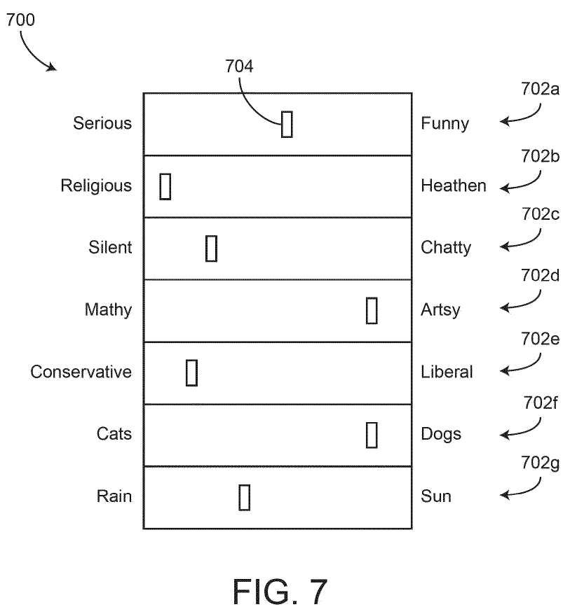

Referring still to FIG. 2, profile generator 104 (e.g., data collector 208) can be configured to learn the user 112 (e.g., details about the user, preferences of the user, facts about the user, language characteristics of the user, etc.) over time (e.g., over a data collection phase). In addition to slidable settings as described in greater detail below with reference to FIG. 7, data collector 208 can send notifications to user 112 via user device 110 (e.g., asking questions such as “What is your favorite color?”, “What is your favorite movie?” etc.) to obtain answers from the user 112 as collected data. These notifications can be generated and provided to the user 112 to capture data from the user 112 to propagate the user 112 into the future, and also to build a template of the user 112 so that future automatic postings or communication via profile 106 imitate, simulate, etc., user 112 in accordance with the template (e.g., if the user’s 112 favorite movie is Star Wars, then profile 106 may post memes of Yoda, etc.). The collected data (e.g., the answers the user 112 provides to the notifications) can be used by data collector 208 to adjust or hone the template (e.g., using a machine learning technique, a predetermined set of rules, a neural network, etc.) which can be used by profile 106 for generation or new content (e.g., new posts, messages, etc.). The template of user 112 can also be provided to and used by AI engine 228 (e.g., for chat features of profile 106).

Data collector 208 can also obtain login credentials or access to different social media profiles from the user 112 via user device 110. Data collector 208 may then access server 108 using the credentials or access provided by the user 112 to obtain accessed data from the server 108 (e.g., social media posts, stored photos, videos, etc.).

Data collector 208 can also obtain data (e.g., media such as music, photos, videos, message conversations, notes, calendar events, GPS data, etc.) from local storage of the user device 110. The user 112 may allow cloud computing system 102 to access local storage on user device 110 so that data collector 208 can obtain required data from user device 110. In some embodiments, the user 112 can select which of multiple categories of local data storage to which data collector 208 has access.

Data collector 208 can work in combination with GUI manager 210. For example, GUI manager 210 can generate a GUI for user device 110 to prompt the user to provide various input data, permission to access local storage, login credentials, etc.

### GUIs

Referring still to FIG. 2, profile generator 104 includes GUI manager 210. GUI manager 210 is configured to generate a graphical user interface for user device 110 during data collection. In some embodiments, GUI manager 210 is configured to generate GUIs for the profile 106 when profile 106 is launched on a social media platform (e.g., a server). For example, GUI manager 210 can include instructions regarding a layout of profile 106 (e.g., an arrangement or template of how content should be displayed on profile 106 when initiated on a social media platform). The layout of profile 106 can be selected or set-up by the user 112 during a set-up or configuration phase (e.g., a training period or before the profile 106 is launched). In this way, the user can determine or select a desired GUI, layout, presentation style, color, etc., of profile 106. GUI manager 210 can store the user’s desired GUI (e.g., layout, template, arrangement, color, text/font, media presentation style, etc.). In this way, the user 112 may customize a manner or a theme of profile 106 presentation.

The user 112 can also indicate a theme for presentation of profile 106 (e.g., a theme setting for content presentation of profile 106). For example, the user 112 may select from different religious themes, cultural themes, movie themes, political themes, personality themes, or settings, etc. In another example, the user 112 may desire to have a Buddhist inspired profile 106. A desired theme of the GUI of profile 106 can be provided to GUI manager 210 by user device 110.

### Messaging Features

Referring still to FIG. 2, profile generator 104 includes message manager 212, according to some embodiments. Message manager 212 is configured to obtain input information or settings from user device 110 for messaging functionality when profile 106 is launched or initiated. For example, the user 112 may indicate that particular messages should be posted or sent to different users at scheduled intervals (e.g., at periodic intervals, on particular dates, on certain holidays, etc.). The messages can be pre-determined (e.g., by the user 112 via user device 110). In some embodiments, the message manager 212 is configured to store responses as determined by the user 112. For example, if one of users 114 sends profile 106 a message (e.g., “I miss you”), message manager 212 can store a predetermined response message that is provided to the user 114 (e.g., “I miss you too”).

In some embodiments, message manager 212 is configured to use a neural network to facilitate intelligent interaction or messaging with users 114 via profile 106 or a messaging service of profile 106, even when profile 106 is inaccessible by user 112. The neural network may user various messaging data or other input data from the user device 110 as training data to generate a model for interacting with the users 114. In this way, message manager 212 may simulate communication between the users 114 and the user 112 via profile 106 even when profile 106 is inaccessible by user 112.

In some embodiments, the profile 106 is configured to provide pre-selected images, quotes, messages, etc., to be sent to friends and/or family during liminal events in their lives. For example, message manager 212 can store various messages and corresponding content to be sent to the friends or family of user 112 at particular points in time or at certain events. These messages can be similar to an “only open when” letter. For example, if a family member gets married, the profile 106 can provide a particular message including pre-selected content, as determined by the user 112 and stored in message manager 212.

### Content Expungement and Data Filtering

Referring still to FIG. 2, profile generator 104 includes filter manager 214, according to some embodiments. Filter manager 214 is configured to filter, purify, remove, or expunge content from the training data (e.g., the input data obtained from user device 110 and/or the accessed data obtained from server 108) according to one or more user preferences or settings (e.g., as obtained from user 112 via user device 110). For example, filter manager 214 may be configured to remove any unwanted political, sexual, anti-social, etc., images, media, commentary, etc., from the profile 106 and/or from the training data used to generate the profile 106. The data collector 208 can obtain an input from the user 112 indicating a manner in which the user 112 wishes to be viewed or presented via profile 106. For example, the data collector 208 can prompt the user device 110 to ask the user 112 if the user 112 desires to appear according to different predetermined roles (e.g., priest, boy-band member, family-oriented, artist, etc.) and expunge the training data or the profile 106 accordingly. In some embodiments, filter manager 214 is also configured to filter or expunge content according to various religious themes, cultural themes, etc. The filter settings or configuration settings can indicate one or more categories of content or specific content for removal when profile 106 is generated or provided to users 114.

### Memory Features

Referring still to FIG. 2, profile generator 104 includes memory manager 216, according to some embodiments. Memory manager 216 is configured to obtain one or more memories from user 112. The memories can be provided by user 112 (via user device 110) as audio files, text descriptions, video files, images, etc., from a particular date of the life of the user 112. In some embodiments, the memories include a corresponding date and location. The memory manager 216 can index and store multiple memories of the user 112, which can be presented to users 114 via profile 106 (e.g., on a same date, periodically, as content in feed of the profile 106, etc.). In some embodiments, the memories also include one or more reminiscences of the user 112 regarding the particular memory. For example, the user may provide a text, video, or audio description of the memory.

Profile 106 can then present the memories to the users 114 (e.g., in direct messages, as a post to a feed of profile 106, at scheduled intervals, etc.). For example, on Dec. 25, 2025, the profile 106 can post one or more memories from previous December 25^{th} dates (e.g., from Dec. 25, 2025).

### Digital Inheritance

Referring still to FIG. 2, profile generator 104 includes inheritance manager 218, according to some embodiments. Inheritance manager 218 can be configured to obtain or receive access to one or more digital possessions (e.g., BitCoin, cryptocurrency, music files, movie files, digital real estate, video game access, etc.) from user 112 (e.g., via login credentials to one or more digital media platforms). Inheritance manager 218 can also include a particular user 114 that each of the digital possessions or non-digital possessions should be given to (e.g., one or more recipients) as a bequest. After the profile 106 is launched or activated on the social media platform, the profile 106 can be configured to provide the digital possessions to the recipients (e.g., to particular users 114) by providing access to the digital possession (e.g., via an SMS message, a direct message, an e-mail, etc.). The recipients can be provided with access to the digital possession that the user 112 opts to bequeath at a scheduled time (e.g., on the recipients birthday) or when the user 112 loses access to profile 106 (e.g., when the user 112 dies). In this way, the user 112 can set up or configure profile 106 to bequeath various digital possessions to different inheritors or recipients (via profile 106) after the user 112 dies. In some embodiments, profile 106 is configured by inheritance manager 218 to automatically designate the digital possessions to a particular user (e.g., a family member, a surrogate, a lawyer, etc.) who can be contacted in order to transfer the digital possessions to intended recipients. The inheritance manager 218 can also include a list of non-digital items as well as which users should receive the non-digital items. In some embodiments, the digital items include third party social media accounts. The user 112 can identify what he/she wishes to be done with the third party social media accounts upon the user’s 112 passing. In some embodiments, the digital items includes user names and passwords for the third party social media accounts or instructions of where to find the user names and passwords (e.g., a location in a house). In some embodiments, the inheritance manager 218 is configured to generate signed letters that can be sent by the next of kin to the third party social media sites to take down or erase the user’s 112 data upon passing.

In some embodiments, items requiring signature may trigger an online notary public who can verify the user 112 and countersign before the items (e.g., digital or non-digital) are released to the other users. In some embodiments, cryptocurrency can also be identified and inheritors of the cryptocurrency can be listed. In some embodiments, multiple users 112 can inherit certain digital items such as photos, videos, texts, emails, etc. In some embodiments, users 112 that inherit certain digital items are not notified if other users inherit the same digital item.

In some embodiments, inheritance manager 218 also stores a medical will, living will, or other documentation relating to the user 112. For example, the medical will may indicate if the user 112 wishes to be an organ donor, wishes to be intubated, on life support, etc. In some embodiments, the medical will requires authentication or signature using finger print or facial recognition of the user 112. In some embodiments, the medical will is provided (e.g., by the inheritance manager 218) to the user’s 112 next of kin so that if the user 112 is injured, in a car accident, in the hospital, etc., the next of kin will have the medical will information. Other documents that may be included are a medical power of attorney, financial power of attorney, etc.

In some embodiments, inheritance manager 218 is configured to store only a single will or digital inheritance instructions at a time. Updating or editing the digital will (e.g., by the user 112) may delete a previous version of the will and store a current version. In some embodiments, signature is required to edit or update the digital will (e.g., touch ID such as fingerprint or facial recognition).

Inheritance manager 218 can be configured to generate, populate, and provide a bequeathing section of profile 106 to user 112. The bequeathing section may identify or include a listing of one or more digital inheritance items for one or more users 114. The digital inheritance items can include music, photos, videos, movies, cryptocurrency, virtual real estate, video game prizes, etc.

### Advice Section

Referring still to FIG. 2, profile generator 104 is shown to include advice manager 220, according to some embodiments. Advice manager 220 is configured to obtain input data or information from user 112 regarding specific advice. For example, advice manager 220 can be configured to obtain advice data from user 112 regarding love, life, how to fix an oil leak, products to use (e.g., “use a spray like WD-40™ on your lawnmower at the beginning of each spring”), or any other topics. When profile 106 is generated by profile generator 104 and launched, profile 106 can include an “advice section” or can periodically post advice content. The advice section or the advice content can be viewed or accessed by the users 114.

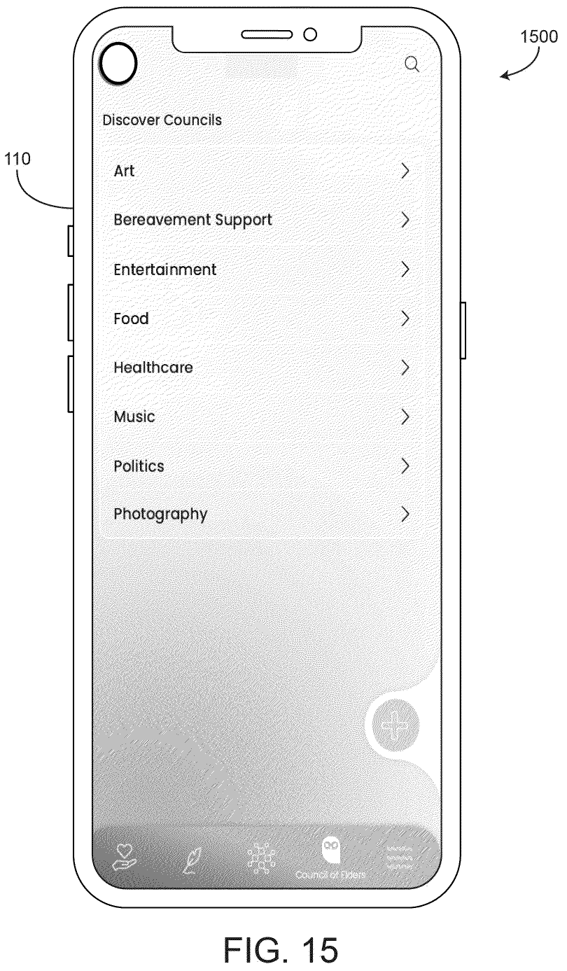

In some embodiments, advice manager 220 is configured to set up profile 106 to communicate with other profiles 106 to cooperatively form a communal advice section (e.g., as shown in FIG. 15). For example, profile 106 can communicate with other profiles on the social media platform and can also use a virtual reality engine (as described in greater detail below) of each of the profiles. The profile 106 can present crowdsourced advice (e.g., from multiple different profiles on the social media platform) to users 114. In some embodiments, advice manager 220 and VR engine 230 are configured to cooperatively function to present a virtual reality experience to user 114 via a VR device to present the crowdsourced advice to the users 114.

In some embodiments, advice manager 220 is configured to generate and provide multiple communal advice sections which are presented to users 114 based on different categories or sectors of experience (e.g., business, medicine, law, relationships, etc.). In some embodiments, advice manager 220 or profile 106 is configured to present the different communal advice sections available to younger users 114 by sector in response to a request from users 114. For example, users 114 may navigate through profile 106 where users 114 may select “Advice from the council of elders” (e.g., the communal advice sections) and then select from multiple different categories (e.g., business, medicine, law, relationships, etc.) or sub-categories. In some embodiments, the users 114 can generate sub-categories, while the categories are general topic guidelines that are predetermined (e.g., healthcare, law, finance, etc.). The users 114 may then input a question such as “How do I make partner in under 1 year?” or “What is the secret to a happy relationship?” etc. Different profiles 106 which are generated from users 112 with appropriate wisdom (e.g., a lawyer with 30 years of experience) may then respond to the user’s 114 question to provide advice. In some embodiments, the user 114 can also provide a score or feedback to the different profiles 106, rating the provided advice. Different profiles 106 can then be ranked (e.g., based on category) based on the score or feedback, and profiles 106 that routinely provide high rated advice may be preferred to provide advice for future requests from users 114. For example, when different profiles 106 answer a question posed, other profiles 106 can like the answer to the question. A total number of likes on answers posted by a particular profile 106 can determine a rank or badge for the particular profile 106. As a result, rankings can be based on expertise that is determined by the number of likes of answers posted.

The communal advice sections can include an emotional support section. Under this sub-heading, users 114 may receive help or advice from each other through bereavement or may be redirected to 3^{rd} party self-help online therapy groups.

### Wish Section

Referring still to FIG. 2, profile generator 104 is shown to include wish manager 222, according to some embodiments. In some embodiments, the user 112 may provide (e.g., via user device 110) one or more unfulfilled wishes that are to be displayed on a wish section of profile 106. Wish manager 222 can store the wishes of user 112 for display on profile 106 (e.g., when user 112 dies). For example, the profile 106 can include a wish (e.g., “I wish I could have 100 trees planted in my name as my legacy”) so that users 114 can view and fulfill the wishes of user 112. The wishes can be provided to the users 114 on a fulfillment section or a wish section of profile 106 that is generated by wish manager 222.

In some embodiments, the wishes can be tagged (e.g., by the user 112). The tag may indicate a level of accessibility or visibility for the wishes. For example, the tags can be for a particular individual, a particular set or group of individuals, a family, the general public, etc. The tags can result in the wishes of the wish section of profile 106 being viewable by different users (e.g., viewable by the particular individual, the particular set or group of individuals, the family, the general public, etc.). In some embodiments, the tags can also allow visibility to some users, but only allow particular users to fulfill the wish. For example, the wishes can be publicly viewable, but may be only fulfilled by the family of the user 112 (e.g., if the user 112 tags the wish as such). In this way, the user 112 can toggle privacy of different wishes.

In some embodiments, the tags of the wishes facilitate searching of wishes of different users. For example, the user 112 may search for different wishes of other users (e.g., using a search feature, a search function, etc.) and can fulfill stranger wishes (e.g., based on location or search terms). In some embodiments, users may fulfill others users wishes based on privacy settings of the wishes. For example, a user classified as the general public, relative to a second user, may be limited from viewing and fulfilling wishes of the second user, unless the second user has tagged the wishes to be visible to all users classified as the general public.

In some embodiments, wish manager 222 may track a number of wishes completed by a particular user (e.g., by the user 112) and can generate a badge or rank based on the number of wishes that the particular user has completed. The badge or rank can be displayed on the profile 106 of the user 112.

In some embodiments, wish manager 222 is configured to cause the profile 106 of a user to automatically reply when another user fulfills a wish on the wish section. For example, if one user tags another user (e.g., a daughter or son) in a wish to plant ten trees in her name, the profile 106 can automatically provide a message, a video, a thankyou note, etc., in response to the other user (e.g., the daughter or son) fulfilling the wish. In some embodiments, the message, video, thankyou note, etc., is pre-generated by the user when the user creates the wish. When the other user confirms that the wish has been completed, the message, video, thankyou note, etc., is provided to the other that completed the wish (e.g., a video from the user’s mother).

### Donation Features

Referring again to FIG. 2, profile generator 104 may include donation manager 224. Donation manager 224 can be configured to receive (e.g., from user 112 or user device 110) one or more charities, non-profit organizations, or other organizations to which user 112 desires the users 114 to donate. The charities or organizations to which the user 112 wishes users 114 to donate can be provided to donation manager 224 as input data during a set-up or generation period of profile 106. Once profile 106 is generated, profile 106 can include a donation section with a list of the charities or organizations and links or ways for users 114 to donate to the charities or organizations.

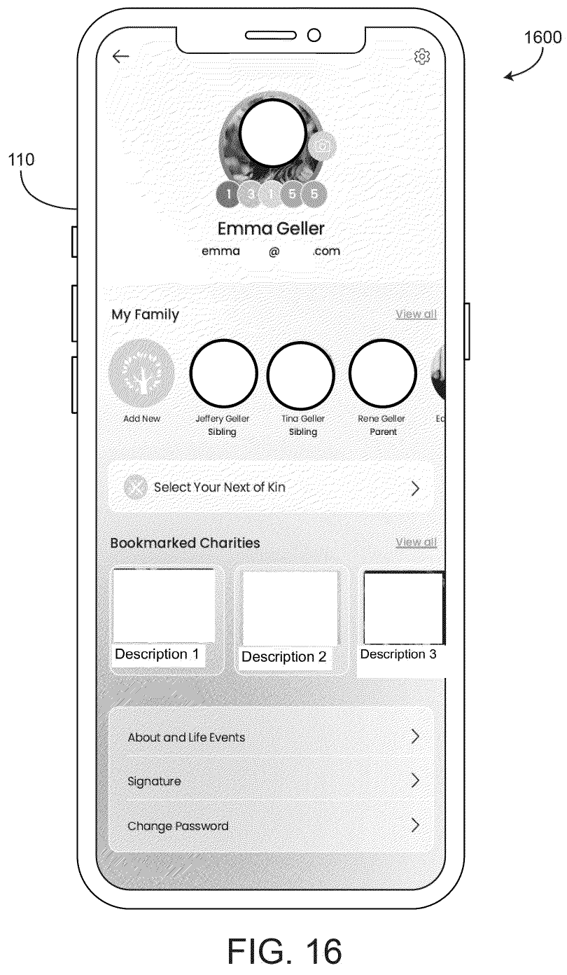

In some embodiments, profile 106 includes a button or selection (e.g., a “giving back” button) that causes the profile 106 to present 1) wishes that the profile 106 is tagged in (e.g., by loved ones, friends, etc., who have wishes that they want the user of the profile 106 to fulfill), 2) a general view of wishes for the profile 106 (e.g., wishes of other users in the community, etc.), 3) charities (e.g., a medicine san frontier, a local community service, etc.) or 4) fundraisers that the profile 106 is tagged in (e.g., GoFundMe). When the profile 106 completes a “giving back” operation, the profile 106 can be assigned different badges or icons for each giving back operation that are viewable by other profiles of users. For example, when the profile 106 completes an environmental giving back operation (e.g., fulfills an environmental type wish, donates to an environmental charity, etc.), the profile 106 can be provided with a green circle. In another example, when the profile 106 completes a political giving back operation (e.g., donating to a political organization, etc.), the profile 106 can be provided with a blue circle. The circles can be closed to indicate that the wish or donation has been completed. In some embodiments, an amount of time or monetary amount that must be provided to obtain a circle for any of the different categories or fields (e.g., environmental, political, etc.) can vary based on geographic region. For example, for a profile 106 of a user from the United States, the user may be required to donate 10 hours of time or 150 dollars to close one circle. In other countries or regions where income is lower, the amount of time or monetary amount can be adjusted to account for the different income levels. FIG. 16 shows a user interface 1600 of a user including different circles indicating scores associated with different giving back operations, scores, or number of giving back tasks completed.

These completed circles can be listed as badges on the profile 106 of the user. Each time the profile 106 obtains another circle, other users or profiles can be notified (e.g., by the profile 106 automatically posting on a feed), or sending messages to other 3^{rd} party social media platforms. In some embodiments, when the user of the profile 106 passes or dies, the number of completed circles of each type (e.g., number of green circles, yellow circles, pink circles, etc.) can be listed on the profile 106. The circles for completed giving back actions can also allow other users to engage in other services such as giving back to profiles 106 with a specific number of completed circles (e.g., a coffee shop may have a special for a day so that all users with 20 pink circles can get a free coffee, a celebrity may host a party or concert where profiles 106 with 50 green circles or more get free admission, etc.).

### Image and Media Management

Referring still to FIG. 2, profile generator 104 is shown to include image manager 226, according to some embodiments. Image manager 226 is configured to aggregate image or video data obtained from user device 110 and/or server 108 and sort the image or video data according to albums. Image manager 226 is configured to sort and store the various multimedia files that the other components of profile generator 104 use. Image manager 226 can be configured to store photos, videos, free text, voice notes, music, etc., that are provided or uploaded by a user. In some embodiments, the user can tag each item or file stored in image manager 226 to indicate which users can view the items or files (and/or which users will inherit the items or files).

### Artificial Intelligence Engine

Referring still to FIG. 2, profile generator 104 can include artificial intelligence (AI) engine 228. AI engine 228 is configured to implement a neural network for performing interactive features between profile 106 and users 114. For example, AI engine 228 can be an AI-based chatbot so that users 114 can interact with profile 106 via direct messaging and conversations.

The AI-based chatbot can be generated or configured by a machine learning technique using the training data. The training data can include text messaging conversations, direct message conversations, etc., or a database or repository thereof including conversational data. The machine learning technique can use the database or repository of the conversational data to train or generate the AI-based chatbot. The AI-based chatbot may then imitate or use similar phrases, language, words, idioms, jokes, mannerisms, etc., of the user 112 so that the AI-based chatbot elicits greater responsiveness from users 114, or imitates user 112. In this way, the users 114 may have the experience of interacting and chatting with user 112 via the AI-based chatbot even when the user 112 is deceased or otherwise inaccessible.

### Virtual Reality Engine

Referring still to FIG. 2, profile generator 104 can be configured to initiate or set up virtual reality (VR) engine 230 for profile 106. In some embodiments, VR engine 230 functions in combination with AI engine 228. Profile 106 can use VR engine 230 to provide users 114 with an interactive virtual reality experience of user 112. For example, each user 114 may interact with profile 106 through a mobile application that supports VR. The mobile application can communicate with profile 106 and the VR engine 230, and a VR headset. VR engine 230 and AI engine 228 can provide various display data for the VR headset so that the user 114 is provided with an immersive experience where the user 114 can interact with (e.g., converse with) a virtual representation of user 112.

In some embodiments, the user 114 can virtually interact with multiple profiles 106. For example, the mobile application may interact with several profiles 106 of different users 112. The profiles can provide VR data (e.g., via VR engine 230) to interact with the user 114, or to interact with each other. In this way, the user 114 can be provided a “council of elders” immersive virtual reality experience, where the user 114 can virtually interact with multiple profiles 106 simultaneously.

### History Manager

Referring still to FIG. 2, profile generator 104 can include history manager 232, according to some embodiments. History manager 232 can be configured to store one or more textual, oral/audio, or video history media files of user 112 (e.g., a digital journal) and provide the oral or video history media files on a history section of profile 106. User 112 can use user device 110 to record audio or video files regarding different events that occur during the life of user 112 (e.g., national pandemics, presidential elections, etc.). The history media files of user 112 can include recordings of the user 112 describing, for example, “what is was like to live through the COVID-19 pandemic” or describing the user’s subjective experiences during different national, worldwide, or personal historic events. These videos can then be provided to users 114 (e.g., via profile 106, via a section of profile 106, via new content posted to a feed of profile 106) after the user 112 can no longer access profile 106 to digitally propagate user 112 into the future.

### Question and Answer (Q&A) Manager

Referring still to FIG. 2, profile generator 104 can include Q & A manager 234, according to some embodiments. Q & A manager 234 can be configured to obtain data regarding in-depth question and answers regarding the user 112. Profile generator 104 can prompt user 112 or can initiate a process to collect or obtain question and answer date from user 112. Q & A manager 234 uses the collected question and answer data to construct a question and answer section, or interactive application for users 114 to participate in a question and answer activity (via profile 106). The question and answer data can be provided to users 114 (e.g., to family members, friends, etc.) on a question and answer section of profile 106. In some embodiments, the question and answer section is accessible by a family tree service. For example, the question and answer section of profile 106 may include “What is your favorite color?”, “What was your favorite music”, “Who is your favorite actor?”, “What was the scariest moment in your life?” etc.

### How-To Manager

Referring still to FIG. 2, profile generator 104 can include how-to manager 236, according to some embodiments. How-to manager 236 can be configured to collect, obtain, or receive how-to information (e.g., in the form of video files, audio files, text files, etc.) from user 112 before profile 106 is inaccessible by user 112. Profile 106 can be generated with a how-to section so that users 114 can access the how-to information via profile 106. In this way, the how-to information can be provided to users 114 even after profile 106 is inaccessible by user 112. For example, the how-to section can include video or audio files of “how to make the best pancakes” or “how to change a spark plug” etc., as recorded by user 112.

### Favorites Manager

Referring still to FIG. 2, profile generator 104 includes favorites manager 238, according to some embodiments. Favorites manager 238 is configured to obtain lists of favorite items, places, things, etc., from user 112 for different categories. For example, favorites manager 238 can be configured to receive and store favorite lists from user 112 regarding favorite places in the world, favorite songs, favorite foods, etc. In some embodiments, the category of the favorites list is selectable or customizable by user 112. The favorites lists can be provided to the users 114 (after the profile 106 is inaccessible by user 112) under a favorites section of profile 106. The favorites lists may also include links to websites or webpages that the users 114 can access to view the different items on the favorites lists. For example, a favorites list of world locations can include links to a VR or map of the location. Similarly, a favorites music section can have links to websites or webpages where the music or songs can be accessed by the users 114. Favorites products section can have links to market place webpages where the products can be purchased by users 114.

### Profile Generation and Activation

In general, profile generator 104 can operate to both step user 112 through a setup process to collect data for generation of profile 106 and can continuously operate to collect additional data (or prompt the user 112 to enter additional data). For example, when the user 112 launches an application on user device 110 that facilitates communication between user device 110 and cloud computing system 102, profile generator 104 can proceed to provide a series of questions and input fields for user 112. For example, profile generator 104 can provide a welcome page having a choice of options with cascading options depending on preferences of user 112.

For example, the options may include:
Do you wish for your online political and/or sexual comments and images to be scrubbed? Y/N?;
Do you intent for your profile to be religious in nature? Y/N?;
If yes, do you self-identify as Christian, Muslim, Jewish, Buddhist, Hindu, etc.?;
   If Christian do you wish to choose a denomination? Y/N?
Do you wish to choose a standard theme or create your own?
   Choose one of the following themes.
Do you wish to contact family and/or friends in the future during important life events? Yes or no.
   If yes, what is the name and contact detail of your first loved one?
   What event will you want to contact them for? Birthday, wedding, funeral, birth of child, graduation, etc.
      If birthday, would you like this to repeat for 1 year, 5 years, 10 years, in perpetuity? 10 years.
      For each passing year please write what message you would like to send to them in the spaces below.
Each year can have an original message typed by the user or can use a same message annually. For non-predictable events (e.g., weddings, graduations, births, etc.) a message will be sent informing the users 114 (e.g., loved ones) that they have a message from user 112 only to be opened in the event of graduating, or having a child etc.

In this way, cloud computing system 102 can interact with user device 110 to present GUIs and prompts to obtain input data from the user 112 via user device 110. Cloud computing system 102 then uses the input data to construct or generate profile 106. When user 112 dies or is otherwise inaccessible, cloud computing system 102 can determine that an initiation condition has been met. The initiation condition indicates that the user is unable to access or control the profile 106. In some embodiments, administrator 116 notifies cloud computing system 102 that the initiation condition has been met. Once the initiation condition is met, cloud computing system 102 uploads, activates, initiates, launches, or otherwise provides profile 106 to a social media platform, according to some embodiments. For example, cloud computing system 102 can launch profile 106 on server 240 (e.g., a social media server) where profile 106 can be accessed by users 114.

When profile 106 generates new content for presentation on profile 106 (or new content is generated by profile generator 104), profile 106 can use a new content setting that is received by profile generator 104 during generation of profile 106. The new content setting can indicate a category of content to be posted on profile 106 and a condition for posting the new content on profile 106 (e.g., posting the new content in the feed of profile 106). For example, the condition can be when a certain date arrives or when a certain event occurs. In some embodiments, the condition may be an elapse of a predetermined number of days without new content being posted or a predetermined number of profile views for example

The profile 106 can also interact automatically with the users 114 as described herein. The profile 106 can be configured to send direct messages to users 114, respond to a direct message received from users 114, post new content in the feed of profile 106 that are directed towards one or more of users 114, or post new content on the feed of profile 106 that identify one of users 114.

The profile 106 can also include a private message wall or a private message section. In some embodiments, the users 114 can post private messages to the private message wall (e.g., “I miss you” or “Wish you were here” etc.). In some embodiments, the AI-based chatbot is configured to respond to the different private messages posted on the private message wall (e.g., “I miss you too” or “I’m here in your thoughts!” etc.). In some embodiments, the private message wall is accessible only by certain users 114. For example, the private message wall may have a private tag so that the private message wall is viewable only by users 114 with sufficient access levels. The users 114 may be able to view all private messages that are posted on the private message wall (e.g., by other users 114, or by the AI-based chatbot of profile 106). The profile can also include an interactive content section (e.g., a chat window, an interactive Q & A section, etc.) through which users 114 can gain additional information regarding user 112 through interaction with profile 106.

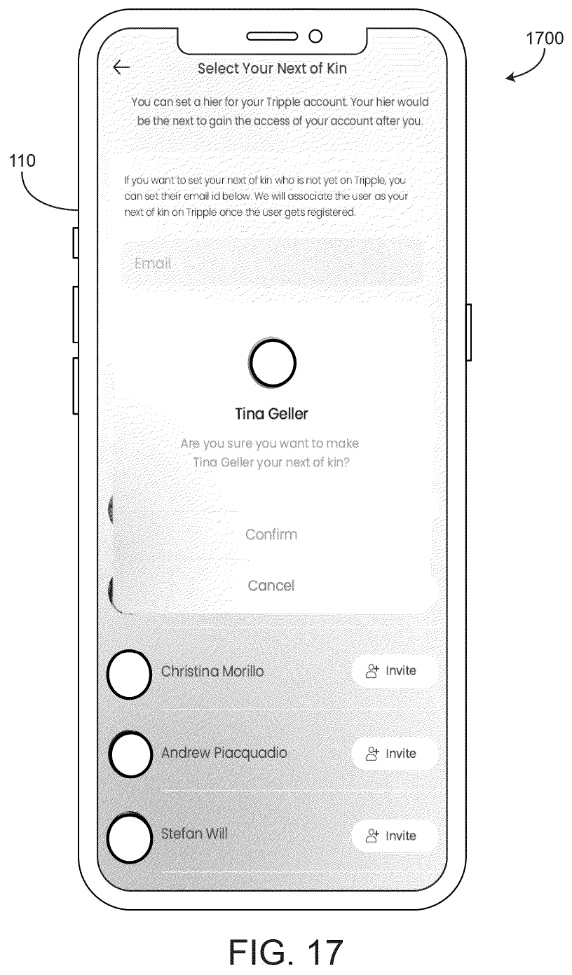

When the user of the profile 106 dies, the digital or non-digital items can be inherited by the users 114 that the user 112 has identified as inheritors. The user 112 may determine which of the digital or non-digital items should be inherited, which items are loaded to a general viewable feed, which wishes are publicly announced, what future messages are propagated at what time, etc. The passing of the user 112 can be triggered by a next of kin user toggling that the user 112 has passed away. Once the next of kin user has indicated that the user 112 has passed away, an email is sent to the user 112 with a prompt to deny this toggle within the next 72 hours (or another specified time period). If there is no denial, then the profile 106 of the user 112 is launched as a digital legacy to propagate the user 112 virtually and the different information, inheritances, digital files, messages, etc., can be sent to different users 114 as tagged by the user 112. In some embodiments, the indication that the user 112 has passed away (as indicated by the next of kin user) may also require confirmation or denial by two other users in a network of friends or family of the user 112 prior to propagating the user 112 virtually or denying such an operation. Once it has been confirmed that the user 112 has died, the cloud computing system 102 or the profile 106 may notify third party social media sites with a preformatted announcement of the user’s 112 passing. The next of kin can be assigned or selected by the user 112 as shown in FIG. 17.

### Processes

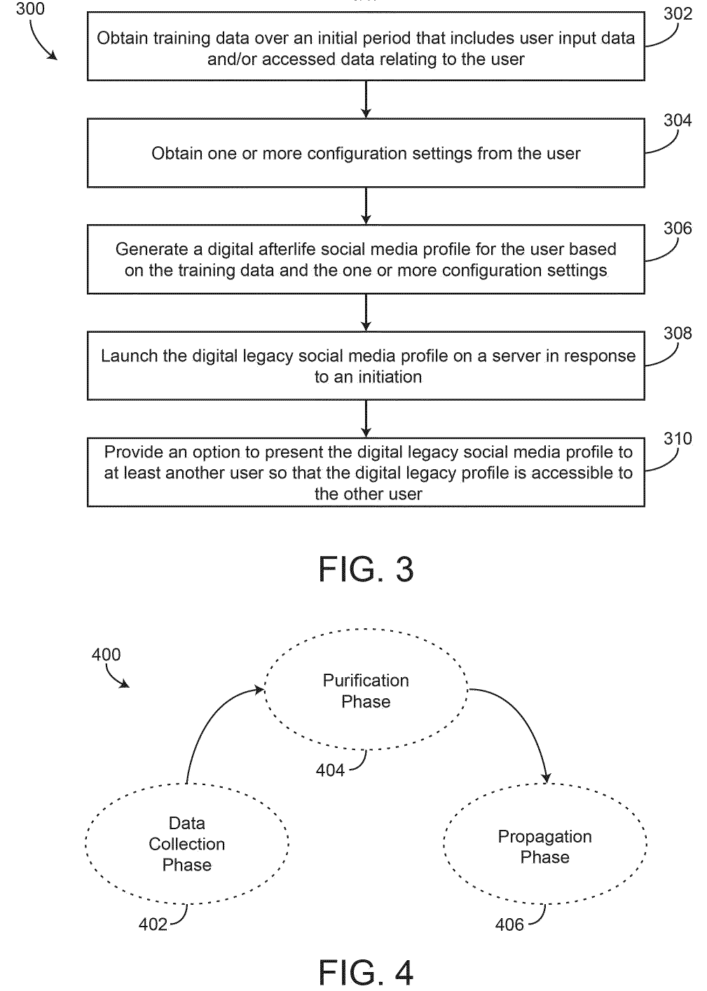

Referring now to FIG. 3, a process 300 for propagating a user virtually (e.g., user 112) via a digital legacy social media profile (e.g., profile 106) is shown, according to some embodiments. Process 300 incudes steps 302-310 and can be performed by digital legacy system 100.

Process 300 includes obtaining training data over an initial period that include user input data and/or accessed data relating to the user (step 302), according to some embodiments. In some embodiments, the initial period is a training time period or a data collection phase (as described in greater detail below with reference to FIG. 4). In some embodiments, the input data is data that is obtained from the user via the user device (e.g., user device 110) or from local storage of user device 110. In some embodiments, the accessed data is data or media that is obtained from a remote data storage or a social media platform. In some embodiments, step 302 is performed by cloud computing system 102, or more particularly, data collector 208 of cloud computing system 102 and user device 110. In some embodiments, the accessed data includes one or more social media profiles or social media profile data of the user. In some embodiments, the input data is provided in response to a prompt for the input data being provided to the user. In some embodiments, the accessed data includes a third party social media profile of the user. In some embodiments, the user provides access to the third party social media profile and data of the third party social media profile. In some embodiments, step 302 includes requesting access to input or training data.

Process 300 includes obtaining one or more configuration settings from the user (step 304), according to some embodiments. In some embodiments, step 304 includes prompting the user to input responses to one or more inquiries that are presented locally at a device of the user and storing the responses. In some embodiments, the one or more configuration settings include a filter setting and one or more nominees. In some embodiments, the filter setting includes a user preference regarding one or more categories of content and/or specific content to be designated as hidden from the digital legacy social media profile. In some embodiments, step 304 is performed by cloud computing system 102, or more particularly, by user device 110 and user 112. In some embodiments, the one or more nominees are one or more users empowered to access or adjust privacy settings or configuration settings of the digital legacy social media profile.

Process 300 includes generating a digital legacy social media profile for the user based on the training data and the one or more configuration settings (step 306), according to some embodiments. In some embodiments, step 306 is performed by profile generator 104 using the techniques described herein. In some embodiments, the digital legacy social media profile is configured to automatically interact with one or more other users and generate new content to populate a feed of the profile. In some embodiments, the new content is generated based on the training data. In some embodiments, the digital legacy social media profile (e.g., profile 106) includes a public profile and a private profile. The public profile can include public content, while the private profile includes private content. In some embodiments, the digital legacy social media profile is configured to send direct messages to another user in response to a scheduled event or date, or in response to receiving a direct message from the other user. In some embodiments, step 306 is performed in response to a determination that an initiation condition is satisfied.

Process 300 includes launching the digital legacy social media profile on a server in response to an initiation (step 308), according to some embodiments. In some embodiments, step 308 is performed by cloud computing system 102. In some embodiments, step 308 includes launching the digital legacy social media profile on a social media platform where it can be accessed by other users.

Process 300 includes providing an option to present the digital legacy social media profile to at least another user so that the digital legacy profile is accessible to the other user (step 310), according to some embodiments. In some embodiments, step 310 is performed by cloud computing system 102, or processing circuitry where the digital legacy social media profile is stored/hosted. In some embodiments, step 310 is performed by a social media platform on which the digital legacy social media profile is hosted.

### Implementation Phases

Referring now to FIG. 4, a diagram 400 shows different phases of implementation of digital legacy system 100, according to some embodiments. Diagram 400 includes a data collection phase 402, a purification phase 404, and a propagation phase 406. During data collection phase 402, digital legacy system 100 functions to collect data from user 112, user device 110, local storage of user device 110, remote storage (e.g., in server 108), etc., for construction or generation of profile 106. During data collection phase 402, digital legacy system 100 may also function to obtain settings for the generation of profile 106 and/or settings for the presentation of profile 106 (e.g., settings indicating which user should be designated as the administrator 116, settings indicating a theme of profile 106, filter settings for purification phase 404, etc.).

Digital legacy system 100 can transition out of the data collection phase 402 and into the purification phase 404 when additional data can no longer be obtained or when user 112 is permanently inaccessible (e.g., upon death of user 112). In some embodiments, data collection phase 402 and purification phase 404 are performed at least partially concurrently. For example, the functionality of digital legacy system 100 can be initiated near an end of data collection phase 402.

During purification phase 404, profile generator 104 can perform its functionality to generate or output profile 106. Profile generator 104 can also use the functionality of filter manager 214 and various filter or expungement settings provided by the user 112 to expunge content from the data (e.g., the training data, the input data, the data related to the user, etc.) that is obtained during the data collection phase 402. In some embodiments, the purification phase 404 is a profile or virtual profile generation phase (e.g., during which profile 106 is generated). The profile is generated by profile generator 104 during the purification phase 404 based on the data collected or obtained during the data collection phase 402, according to some embodiments.

Digital legacy system 100 can transition out of the purification phase 404 and into the propagation phase 406 once the user 112 is permanently inaccessible (e.g., deceased) and the profile 106 has been generated. Transition from the purification phase 404 to the propagation phase 406 can include launching profile 106 on a social media platform (e.g., on a server, on processing circuitry 202 of cloud computing system 102, etc., or in another remote location where profile 106 can be accessed by users 114). Once launched and/or activated, profile 106 can be accessed by users 114 and may interact with users 114 as described in greater detail above with reference to FIG. 2.

### Potential Infrastructure

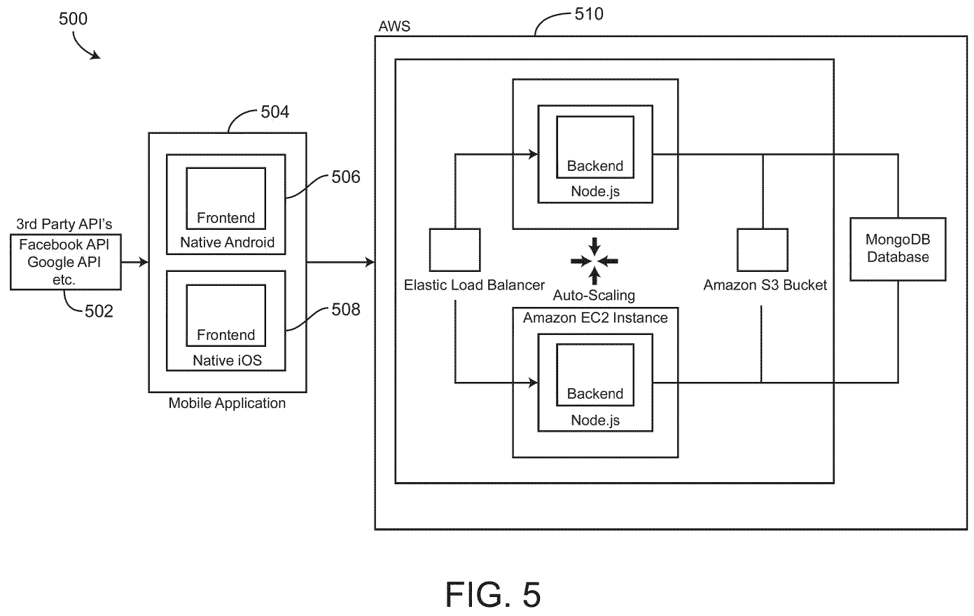

Referring now to FIG. 5, a diagram shows a system infrastructure 500 on which digital legacy system 100, or more particularly, cloud computing system 102 can be implemented. Digital legacy system 100 can be implemented on a cross-platform document-oriented database, such as the open-source MongoDB database provided by MongoDB, Inc. of New York, New York. In some embodiments, persistent data (e.g., data that is infrequently accessed and unlikely to be modified) is stored and retrieved from such a database. In some embodiments, both persistent data and dynamic data may be stored in such a database.

System infrastructure 500 includes 3^{rd} party application programming interfaces (APIs) 502, a mobile application 504, and a web service 510. The web service 510 can be configured to interact with the mobile application 504 and can perform any of the functionality of cloud computing system 102 as described in greater detail above with reference to FIG. 2. In some embodiments, Node Javascript (NodeJS) can be used for backend functions, backend interfaces, business logic, and data access controllers and classes. Frontend user interfaces can be native in Android 506 or iOS 508 and can connect with the NodeJS backend using representational state transfer web APIs. System infrastructure 500 represents one possible implementation of digital legacy system 100.

### User Flow

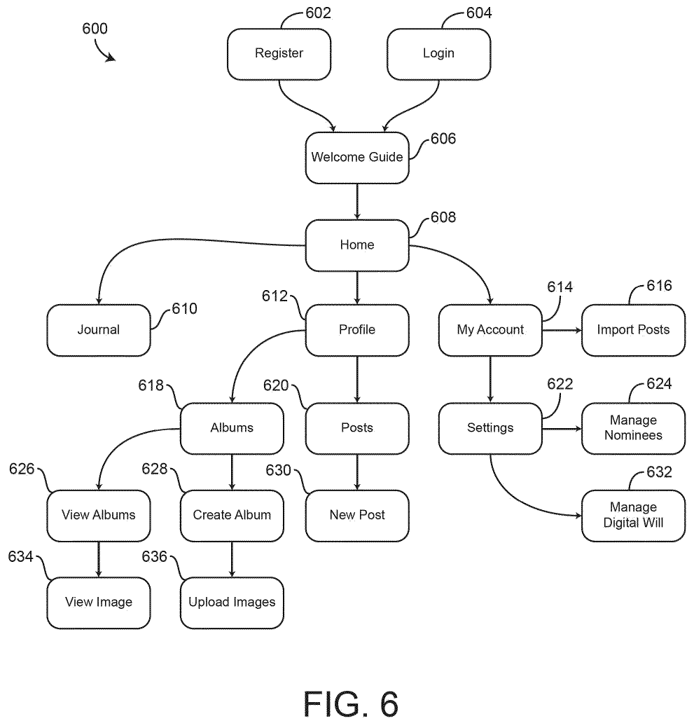

Referring now to FIG. 6, a flow diagram 600 shows different steps or user interfaces that can be provided to a user (e.g., user 112) upon initiation of a mobile application that causes user device 110 to communicate with cloud computing system 102. In some embodiments, flow diagram 600 illustrates a set-up of cloud computing system 102 or interaction between user 112 and cloud computing system 102 to provide cloud computing system 102 with the input data and/or accessed data.

When the user (e.g., user 112) first initiates the application on user device 110 (e.g., a mobile device), the user is presented with either a registration interface 602 or a login interface 604 based on whether the user has an account or not. When the user registers or logs in, the user is next presented with a welcome guide interface 606, followed by a home interface 608. From the home interface 608, the user may select a journal interface 610, a profile interface, or an account (e.g., “my account”) interface 614. At the journal interface 610, the user may add journal entries which can be used in generation of profile 106.

From the profile interface 612, the user can select an albums interface 618 or a posts interface 620. In the albums interface 618, the user may select a view albums interface 626 or a create album interface 628. If the user selects to view a particular album, the user may then view images 634 of the album. If the user selects to create an album by selecting create album interface 628, the user can be presented with an upload images interface 636 where the user may upload images (e.g., from the user device 110 or from different social media accounts). From the posts interface 620, the user may select to create a new post and be presented with a new post interface 630. The user can then be guided through the process for creating a new post. From the account interface 614, the user can import posts by selecting an import posts interface 616 or can select a settings interface 622. From the settings interface 622, the user can select to manage one or more nominees at a manage nominees interface 624, or can manage their digital will through a manage digital will interface 632.

### Slidable Settings

Referring now to FIG. 7, cloud computing system 102 can be configured to control or prompt user 112 to enter settings data via a slider interface 700. Slider interface includes multiple categories 702, and a slider 704 for each category 702. Each category can include two, opposite descriptors and the user 112 can adjust the slider between the two descriptors. For example, slider interface may include slider categories 702a-702g, each with a corresponding slider 704 which the user 112 can adjust between the different descriptors or character toggles.

### Sample GUIs

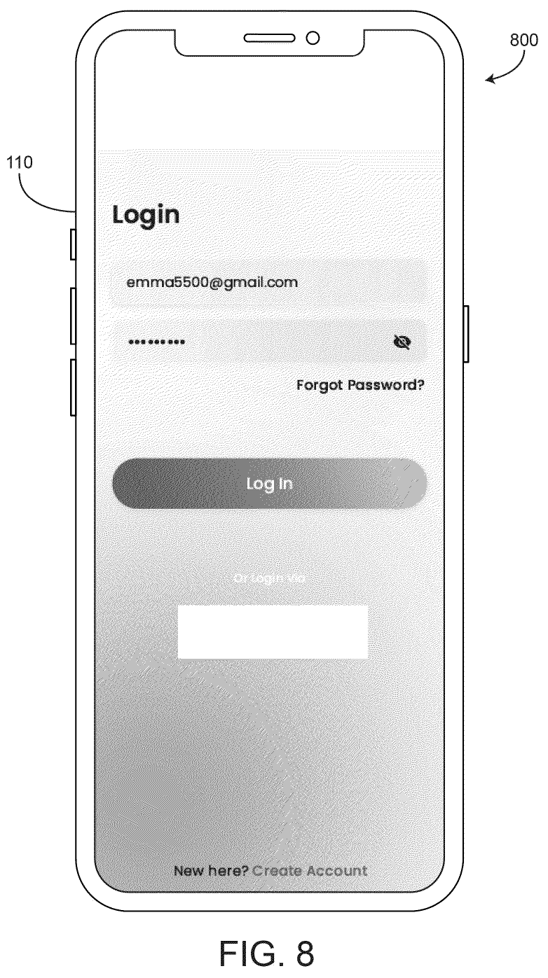

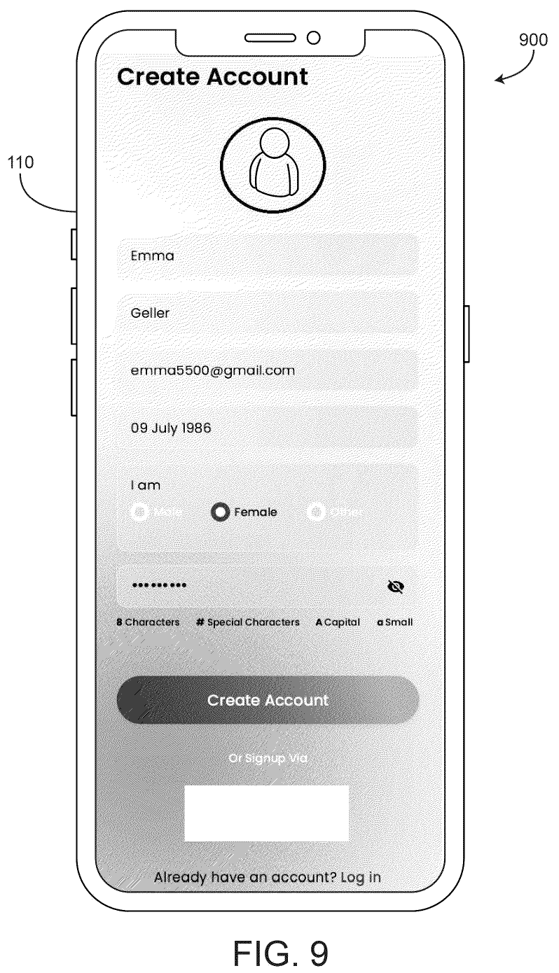

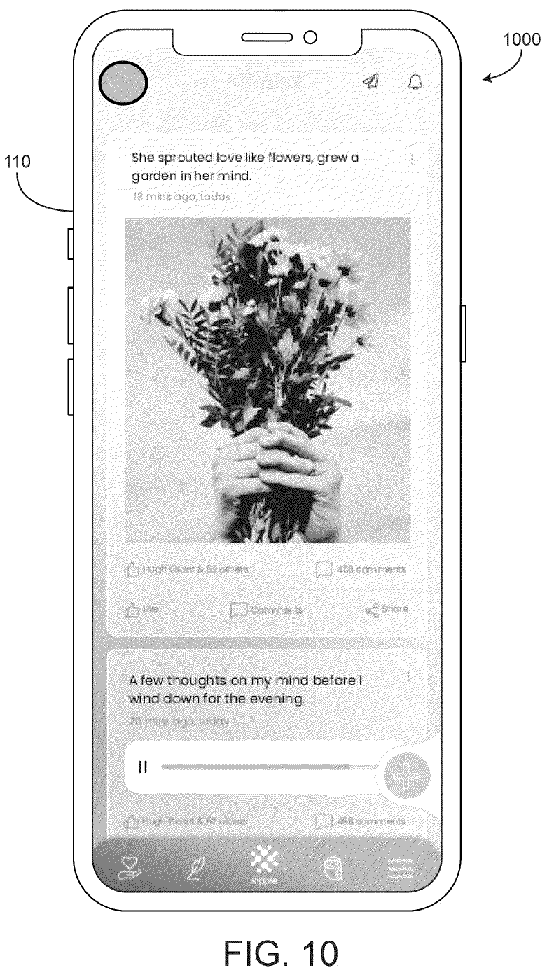

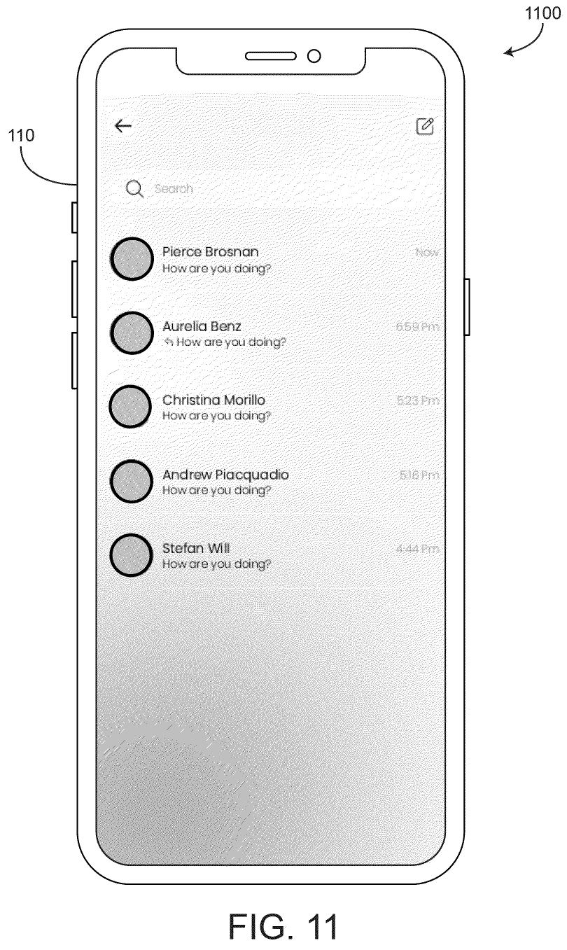

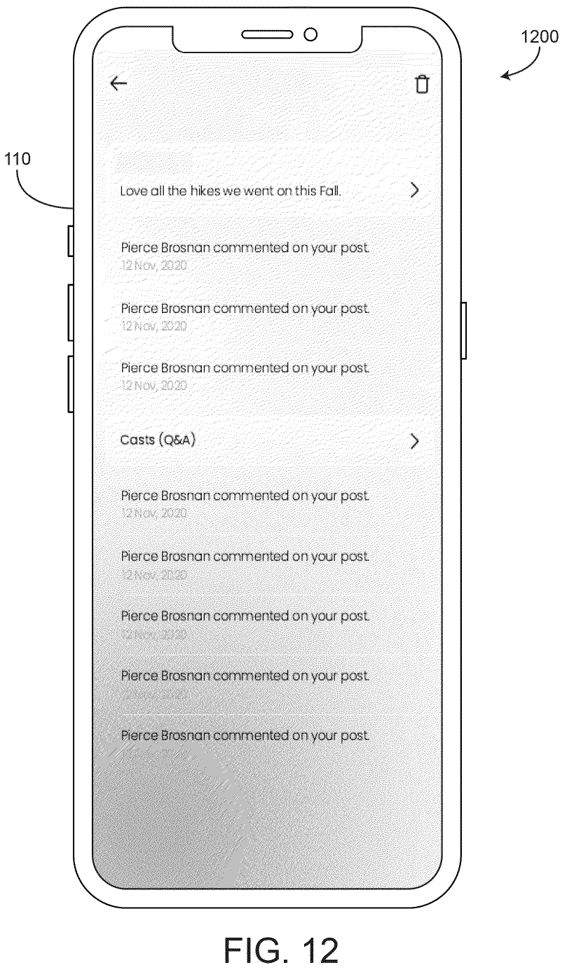

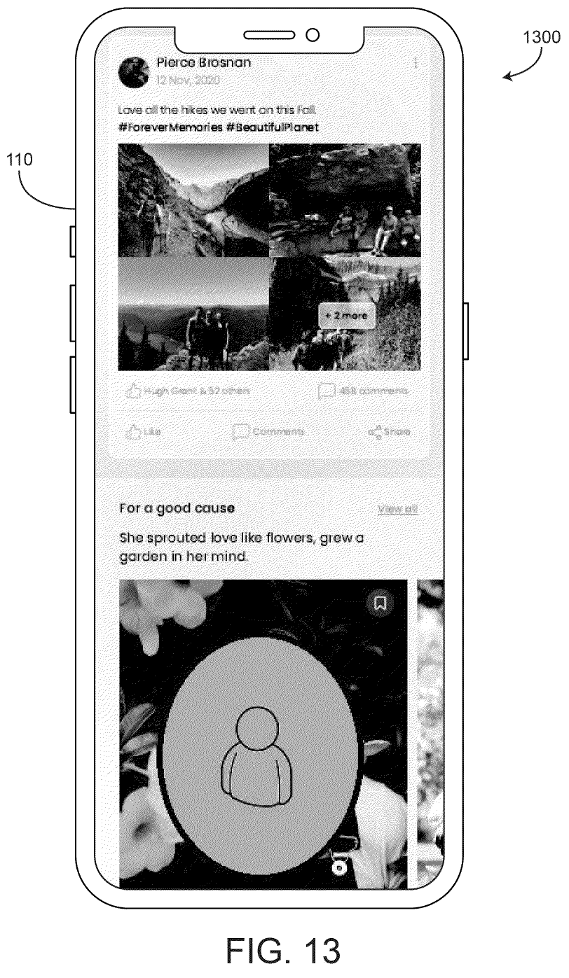

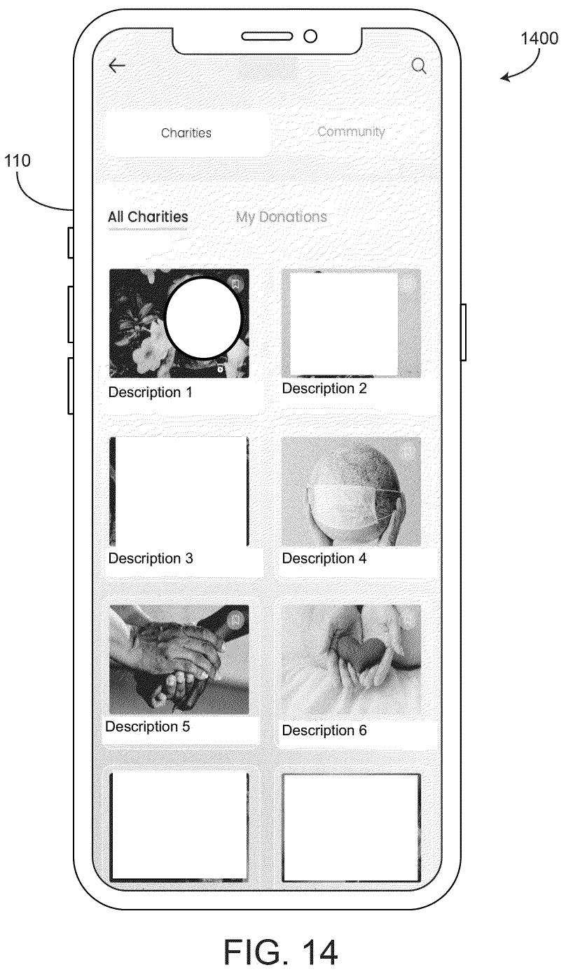

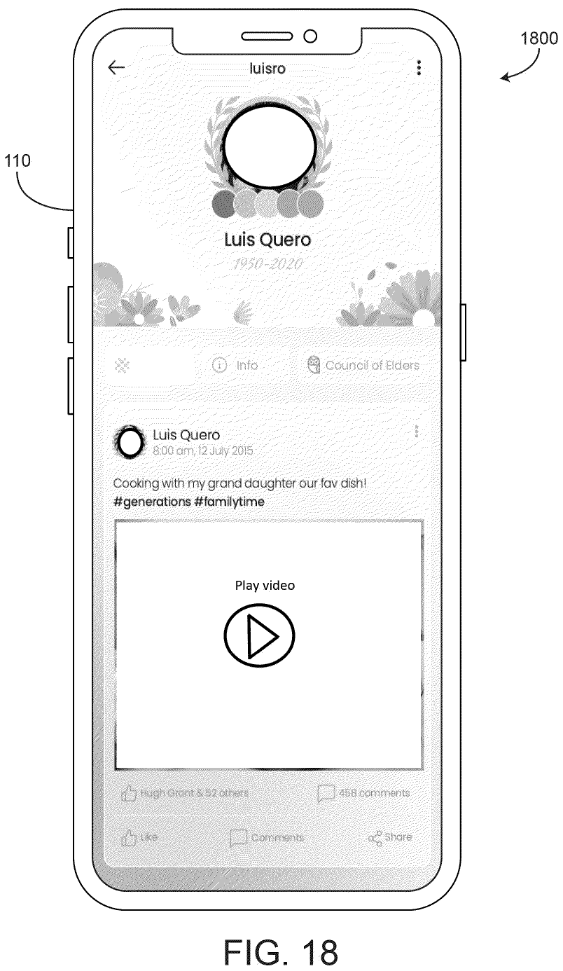

Referring now to FIGS. 8-18, various user interfaces 800, 900, 1000, 1100, 1200, 1300, 1400, 1500, 1600, 1700, and 1800 are shown, according to some embodiments. For example, when a user launches the mobile application, the user may be provided either a login interface 800 (e.g., login interface 604), or a registration interface 900 (e.g., registration interface 602). After the user logs in or registers, the user can be provided with a home or feed interface 1000 (or a welcome interface such as welcome guide interface 606). FIG. 13 shows another feed interface 1300 where the user may select different menus or options, can navigate to adjust different settings, link different accounts, view posts by other users, view giving back options, etc. FIG. 11 shows a message interface 1100 where users may send and receive messages with other users. FIG. 12 shows a notification interface 1200 that shows the different notifications a particular user has received. FIG. 14 shows a charity interface 1400 including different charities that a user can select to participate in. FIG. 15 shows a user interface 1500 for a communal advice section including different topics (e.g., art, bereavement support, entertainment, food, etc.). FIG. 16 shows a user interface 1600 of a profile of a user that may be presented to other users. FIG. 17 shows a user interface 1700 to facilitate a user selecting their next of kin. FIG. 18 shows a user interface 1800 of a profile for a user that is decreased, and whose profile has become a legacy profile. ***

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

As used herein, the singular forms “a,” “an” and “the” include plural referents unless the context clearly dictates otherwise. Thus, for example, reference to “a” component includes aspects having two or more such components, unless the context clearly indicates otherwise. Also, the word “or” when used without a preceding “either” (or other similar language indicating that “or” is unequivocally meant to be exclusive – e.g., only one of x or y, etc.) shall be interpreted to be inclusive (e.g., “x or y” means one or both x or y).

Although the term “user” is employed herein, in some embodiments, the “user” may be a subject on whose behalf a profile is created and/or maintained. Further, in some embodiments, the user may be an agent who has created a profile on behalf of a subject, e.g., a relative of the subject.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems and methods as shown in the various exemplary embodiments is illustrative only. Additionally, an element disclosed in one embodiment may be incorporated or utilized with another embodiment disclosed herein. It should be appreciated that elements of the various embodiments may be incorporated or utilized with any of the other embodiments disclosed herein.

The present disclosure is not to be limited in terms of the particular embodiments described in this application. Many modifications and variations can be made without departing from its spirit and scope, as will be apparent to those skilled in the art. Functionally equivalent methods and systems within the scope of the disclosure, in addition to those enumerated herein, will be apparent to those skilled in the art from the foregoing descriptions. Such modifications and variations are intended to fall within the scope of the appended claims.

What is claimed is:

1. A method for propagating a first user virtually via a digital legacy social media profile, the method comprising:
obtaining training data over an initial time period, the training data comprising at least one of user input data or accessed data relating to the first user;
obtaining one or more configuration settings from the first user, the configuration settings comprising at least one of a filter setting or one or more nominees;
generating a digital legacy social media profile of the first user using the training data and the one or more configuration settings;
launching the digital legacy social media profile on a server in response to an initiation; and
providing an option to present the digital legacy social media profile to at least a second user such that the digital legacy social media profile is accessible to the second user even when the digital legacy social media profile is inaccessible to the first user.

2. The method of claim 1, wherein the accessed data comprises one or more social media profiles or social media profile data of the first user.

3. The method of claim 1, wherein the user input data is provided by the first user in response to a prompt to input data, wherein the prompt is at least one inquiry provided to the first user and the user input data is a response to the at least one inquiry.

4. The method of claim 1, wherein the accessed data comprises a third party social media profile of the first user, wherein the first user provides access to the third party social media profile and data of the third party social media profile.

5. The method of claim 1, wherein the filter setting comprises a user preference regarding (a) one or more categories of content and/or (b) specific content to be designated as hidden from the digital legacy social media profile.

6. The method of claim 1, wherein the digital legacy social media profile is configured to automatically interact with the second user and/or generate new content to populate a feed of the digital legacy social media profile, the new content generated based on the training data.

7. The method of claim 1, wherein the one or more nominees are one or more users empowered to access or adjust privacy settings or configuration settings of the digital legacy social media profile.

8. The method of claim 1, wherein the digital legacy social media profile comprises at least one of a public profile comprising public content or a private profile comprising private content.

9. The method of claim 1, wherein the digital legacy social media profile is configured to send direct messages to the second user in response to:
a scheduled event or date; or
receiving a direct message from the second user.

10. A method for creating a digital legacy profile for a first user, the method comprising:
requesting access to input data of the first user, the input data comprising data or media that is stored locally on a device of the first user and data or media of the first user stored remotely;
obtaining one or more configuration settings from the first user, the one or more configuration settings comprising a filter setting for content expungement, and a theme setting for content presentation;
prompting the first user to input responses to inquiries presented locally on the device of the first user and storing the responses;
determining whether an initiation condition is satisfied, and in response to the initiation condition being satisfied:
generating a digital legacy profile for the first user based on the input data, the one or more configuration settings, and the responses; and
providing the digital legacy profile to a second user.

11. The method of claim 10, wherein the filter setting identifies one or more categories of content or specific content designated for removal when the digital legacy profile is provided to the second user.

12. The method of claim 10, wherein the digital legacy profile is provided to the second user according to the theme setting for content presentation, the theme setting for content presentation comprising at least one of a cultural, a religious, a political, or a personality setting.

13. The method of claim 10, further comprising:
receiving a new content setting, the new content setting indicating a category of content to be posted on the digital legacy profile and a condition for posting the content on the digital legacy profile.

14. The method of claim 10, further comprising:
receiving a setting for an automated reply message, the setting comprising a condition to trigger the automated reply message, and the automated reply message.

15. The method of claim 10, wherein the one or more configuration settings are obtained from the first user via a slider interface, the slider interface comprising a plurality of character toggles for the digital legacy profile, and a plurality of sliders for receiving a value of an associated one of the plurality of character toggles.

16. A method for providing a digital legacy profile for a first user to a second user, the method comprising:
generating the digital legacy profile based on training data and one or more configuration settings;
providing a second user with access to the digital legacy profile according to an access level of the second user;
automatically posting new content on the digital legacy profile based on the training data and the one or more configuration settings, the new content being automatically posted and the digital legacy profile automatically interacting with the second user when the digital legacy profile is inaccessible by the first user; and
automatically interacting with the second user through the digital legacy profile.

17. The method of claim 16, further comprising:
determining whether an initiation condition is met, the initiation condition indicating that the first user is unable to access or control the digital legacy profile; and
in response to the initiation condition being met, providing the second user with access to the digital legacy profile, automatically posting new content on the digital legacy profile, and automatically interacting with the second user through the digital legacy profile.

18. The method of claim 16, wherein automatically interacting with the second user comprises:
sending a direct message to the second user;
responding to a direct message from the second user;
posting new content directed towards the second user; or
posting new content identifying the second user.

19. The method of claim 16, wherein the digital legacy profile comprises at least one of:
a fulfillment section comprising one or more wishes of the first user;
one or more images, quotes, or messages pre-selected by the first user;
an interactive content section indicating additional information of the first user;
a history section comprising media of the first user describing life events;
a private message wall configured to receive at least one private message for the first user from the second user;
an advice section comprising advice from the first user or instructional media from the first user;
a favorites section comprising one or more lists of favorite objects, places, activities, memories, or media;
a donation section configured to receive a donation from the second user and provide the donation to an organization as preferred by the first user;
a bequeathing section for identification of one or more digital inheritance items comprising at least one of music, photos, digital game items, cryptocurrency, or virtual real estate; or
a communal advice section configured to present crowdsourced advice to the second user.

20. The method of claim 16, wherein the digital legacy profile comprises content assigned a private tag and content assigned a public tag, wherein the second user is provided with access to the content assigned the private tag based on the access level of the second user, the access level of the second user assigned by a third user designated as a manager of the digital legacy profile.
